(19) United States
(12) Patent Application Publication
(10) Pub. No.: US 2014/0358923 A1
(43) Pub. Date: Dec. 4, 2014

(54) Systems And Methods For Automatically Determining Text Classification

(71) Applicant: NDP, LLC, Boulder, CO (US)

(72) Inventors: German Nunez, Boulder, CO (US); James Knepley, Westminster, CO (US)

(21) Appl. No.: 14/286,524

(22) Filed: May 23, 2014

Related U.S. Application Data
(60) Provisional application No. 61/827,983, filed on May 28, 2013.

(51) Int. Cl. G06F 17/30

(52) U.S. Cl. CPC G06F 17/30705
USPC 707/737

(57) ABSTRACT

A software product and a method a method determines classification of text displayed within a browser on a computer. A processor within a server is used to generate a consolidated index of tokens contained within the text. The processor is used to identify a first classification of the text by matching each of one or more terms of a first association defined within a rule set with the tokens of the consolidated index. The first association associates the one or more terms with the first classification. The first classification is indicated with the text by interacting with the browser. The server may continually receive characters from a communication stream and report any matched classifications therein.

### RELATED APPLICATIONS

This application claims priority to U.S. Patent Application Ser. No. 61/827,983, titled “Systems and Methods for Automatically Determining Text Classification”, filed May 28, 2013, and incorporated herein by reference.

### BACKGROUND

Certain entities produce information that may be sensitive in nature and given a specific classification based upon the nature of the sensitivity. For example, the government has several classifications that include military or intelligence classifications of Top Secret, Secret, and Classified. Intellectual property may be given a proprietary classification, and other information may be subjected to rules for legal compliance, such as for the Health Insurance Portability and Accountability Act of 1996 and the Safe Harbor act of 1998. In many cases, where information is to be shared between entities, content of that information should be checked against specific concepts before release.

Currently, there is no method for automatically classifying arbitrary information. Common formats for classified documents or sections thereof rely on writing discreetly identified and classified sentences, paragraphs, or sections. However, most information is not written with classification in mind.

Existing programs and products operate as preventative and detective security controls that attempt to prevent certain information from being exposed to unauthorized persons. However, such programs and products focus on preventing release of information through malice or accident, and focus on identifying the information during transmission.

### SUMMARY OF THE INVENTION

Classification and categorization are very similar and appear synonymous to most people. By definition, when you classify, you group together several things that have something in common; whereas, when you tell how the parts of the group are alike, you categorize them. This document discloses processing text to determine a classification of the text, thereby teaching a process of classifying text; however, these classification systems and methods may also be considered to categorize the text without departing from the scope hereof.

Systems and methods disclosed hereinbelow analyze and classify text. Associated terms are identified within the text and classified so that potentially sensitive information is identified. An appropriate classification is made for the information on a section-by-section basis, and for the information in its entirety.

In one embodiment, a method determines classification of text displayed within a browser on a computer. A processor within a server is used to generate a consolidated index of tokens contained within the text. The processor is used to identify a first classification of the text by matching each of one or more first terms of a first association defined within a rule set with the tokens of the consolidated index. The first association associates the one or more first terms with the first classification. The first classification is indicated with the text by interacting with the browser.

In another embodiment, a method classifies text of a communication stream. A server continually receives characters from the communication stream and a processor of the server is used to tokenize the characters to generate a consolidated index of tokens contained within the text. The processor is used to identify a classification of the text by matching each of one or more first terms of an association defined within a rule set with the tokens of the consolidated index. The association associates the one or more first terms with the classification. The classification is reported to a user of the communication stream.

In another embodiment, a software product has instructions, stored on non-transitory computer-readable media. The instructions are executed by a processor to perform steps for determining text classification. The software product includes instructions for interacting with a browser operating on a user's computer to display the text; instructions for generating a consolidated index of tokens contained within the text; instructions for identifying a first classification of the text by matching each of one or more first terms of a first association defined within a rule set with the tokens of the consolidated index, the first association associating the one or more first terms with the first classification; and instructions for interacting with the browser to indicate the first classification with the text.

### BRIEF DESCRIPTION OF THE FIGURES

FIG. 1 shows one exemplary system for automatically determining text classifications, in an embodiment.

FIG. 2 shows the rule set of FIG. 1 in further exemplary detail.

FIG. 3 shows exemplary data of the index and consolidated index of FIG. 1 for one exemplary sentence.

FIG. 4 shows the export data of FIG. 1 with three exemplary sections: a rule set section, a terms section, and an associations section.

FIG. 5 shows the database of FIG. 1 in further exemplary detail.

FIG. 6 shows the associations table of FIG. 5 with exemplary information.

FIG. 7 shows the terms table of FIG. 5 with exemplary information.

FIG. 8 is a flowchart illustrating one exemplary method for automatically determining a classification of text within the text of FIG. 1, in an embodiment.

FIG. 9 is a schematic illustrating exemplary matching between tokens of the text of FIG. 1 and the terms and associations of the rule set.

FIG. 10 shows one exemplary interactive display of the text of FIG. 1, illustrating a highlighted term, and location markers placed along the right hand margin of the view port.

FIG. 11 shows one exemplary system with common gateway interface for automatically determining a classification of text, in an embodiment.

### DETAILED DESCRIPTION OF THE EMBODIMENTS

As used herein, terms, associations, and classifications, have meaning provided below:

A term is a collection of programmatic definitions describing how to identify a specific word or pattern within data. These definitions may be string matches, regular expression matches, sequential term matches (“phrases”), or another type of matching method that is suitable to indicate the presence of a defined entity within the analyzed data.

An association is a collection of terms that, when all component terms that form the association are discovered within the text, the association of those terms is classified as defined.

A classification is an identification used by associations. Classifications are defined in a weighted order such that text having multiple classifications is given the classification with the highest weight. Using the US Government classification system, in which sensitive information is classified as Top Secret, Secret, Confidential, and Restricted, as an example, the Top Secret classification has the greatest weight/importance, followed by Secret, then Confidential, and then Restricted.

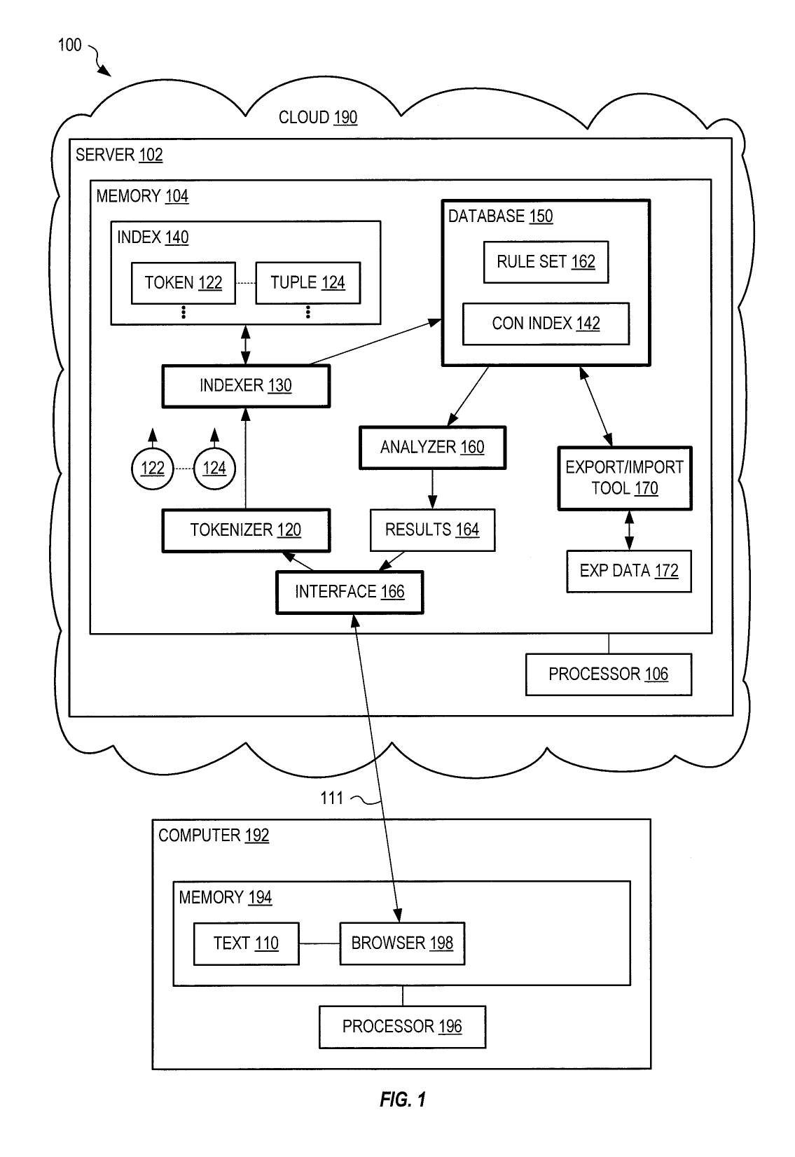

FIG. 1 shows one exemplary system 100 for automatically determining a classification of text. System 100 includes a server 102 with a memory 104 and a processor 106. Server 102 is a computer where memory 104 represents one or more of random access memory (RAM), magnetic memory storage (e.g., a hard drive), FLASH memory, read only memory (ROM), optical memory storage (e.g., CD-ROM, DVD, magneto optical), and so on, as typically used by a computer. Processor 106 may represent one or more digital processors that read and execute instructions from memory 104 to process data. Server 102 is for example located within a cloud 190 and is accessible from remote computers via one or more wired and/or wireless computer networks, including the Internet.

Memory 104 is shown storing a tokenizer 120, an indexer 130, an analyzer 160, and a database 150, where tokenizer 120, indexer 130, and analyzer 160 are software modules that include machine readable instructions that are executable by processor 106 to provide functionality of system 100 as described hereinafter. Database 150 may represent a relational database (e.g., a SQL database) and may also include instructions (e.g., database procedures) that are executable by processor 106 to provide storage and retrieval functionality. In one embodiment, at least part of each of tokenizer 120, indexer 130, and analyzer 160 are implemented as one or more database procedures stored within database 150.

System 100 is shown receiving text 110 (e.g., in the form of a document) from a remote computer 192 via a communication path 111 and an interface 166. Computer 192 is shown with a memory 194 coupled with a processor 196, and may represent a device selected from the group including: a desktop computer, a laptop computer, a tablet computer, and a smart phone. Interface 166 is for example a web based interface that interacts with a browser 198 running on computer 192 to receive text 110. Text 110 represents any electronic format of textual information, such as contained within a document, spreadsheet, email, or other electronic communication that may be electronically processed. Server 102 is for example implemented within cloud 190 and communication path 111 represents a computer network that includes the Internet. However, text 110 may be received within system 100 via other methods, such as from a flash drive, a DVD, and a CD-ROM, without departing from the scope hereof. In one embodiment, not shown, text 110 is received from a remote computer, wherein reports and indications from system 100 are displayed on computer 192.

### Indexing

Text 110 is received and parsed by tokenizer 120 to generate a plurality of tokens 122, each of which is accompanied by a tuple 124. In one example of operation, text 110 is a file (e.g., a text file) that is received by system 100 as a HTTP POST request. In an alternate embodiment, tokenizer 120 is implemented on remote computer 192 such that communication path 111 conveys tokens 122 and tuples 124 from remote computer 192 to system 100. In one embodiment, tokenizer 120 parses text 110 as it is received from computer 192 to generate tokens 122 and tuples 124. Each token 122 is a non-empty sequence of characters that is identified based upon delimiters defined by a POSIX regular expression that matches whitespace and punctuation for example. For each token 122, tuple 124 defines an incremental position number, a byte offset of the first byte of the token within the text, and a sentence number of the sentence within text 110 containing the token, as identified by a period (‘.’) delimiter. Tokenizer 120 converts each token 122 into lowercase, but makes no other conversion; that is, tokenizer 120 does not convert tokens from a variant form (e.g., stemming and conflation) to a canonical form. This simplified approach supports a more easily understood correlation between the configuration and the analysis.

Tokenizer 120 sends tokens 122 and tuples 124, as they are determined, to indexer 130 which stores them within an index 140. Indexer 130 includes a specialized implementation of commonly understood methods to generate index 140 to support Boolean and proximity queries. However, unlike indexers of the prior art that index multiple documents, indexer 130 indexes a single document (i.e., text 110), where that index is temporarily stored only during analysis. Since multiple documents are not cross-referenced, indexer 130 does not include document IDs within index 140.

Once the end of text 110 is reached, indexer 130 processes index 140 to create a consolidated index 142, in which identical tokens are consolidated to a unique token and a list of tuples, and which is formatted for import into database 150. The consolidation step within indexer 130 is an optimized process that imports consolidated index 142 into database 150 more quickly as compared to writing to and updating the database for each token 122, even when the write and update is performed in a single transaction. In an alternate embodiment, tokenizing and indexing are performed in real-time wherein analysis is initiated without waiting for the end of text to be reached. For example, where text 110 represents a communication channel, time-stamps may be included within index 140 and/or consolidated index 142 such that tokens 122 may be analyzed within a sliding time window.

In one example of operation, text 110 contains the sentence: “My care is loss of care with old care done.” Tokenizer 120 generates tokens 122 and tuples 124 without capitalization, and where offset, number, and sentence represent the byte offset, position, and sentence number within text 110. Indexer 130 implements a simplified inverted index that is similar in concept to those used by Internet search engines; however indexer 130 is optimized to only analyze one file at a time and therefore does not index multiple files, as done by conventional indexing tools. FIG. 3 shows exemplary data of index 140 and consolidated index 142 for the above exemplary sentence.

When stored in the SQL database, token 122 is indexed such that associated tuples 124 may be retrieved (i.e., looked up) very quickly across hundreds of thousands (or more) stored terms.

Once consolidated index 142 is imported into database 150, index 140 and consolidated index 142 (i.e., temporary files) are deleted within memory 104 such that consolidated index 142 remains only in database 150. In turn, analyzer 160 is invoked to process consolidated index 142 stored within database 150.

### Analysis

A rule set 162 is created to configure analyzer 160 to generate results 164 based upon identified sensitive associations within text 110. Rule set 162 is, for example, defined to allow analyzer 160 to generate results 164 based upon identified sensitive terms that are associated with one another for a particular organization. Rule set 162 may define one or more classifications based upon one or more sets of terms and associations.

These sensitive terms and associations are typically documented in an information classification guide. Rule set 162 is thus implemented, based upon the information classification guide, as a collection of terms and associations. In one example, an information classification guide and related appendices created by the Department Of Defense (DoD) for a specific program are used to create rule set 162. In another example, information classification guides found in privacy regulations such as HIPPA or COPPA are used to create rule set 162. These information classification guides define a framework and provide guidance for creating rule set 162 to control analyzer 160 to classify at least part of text 110.

The information classification guide itself, particularly in the case of DoD appendices, are frequently classified. Thus, rule set 162 is also classified at the same level as the source document used to create it (i.e., given the same classification as the information classification guide). There is usually a one-to-one correlation of rule set 162 to the information classification guide, although system 100 is not limited to this correlation. For example, rule set 162 may represent a subset of one information classification guide that deals exclusively with sensitive computer credentials for example. System 100 may thus operate with one or more rule sets 162 to allow an organization to implement one or more information classification guides.

### Rule Set Details

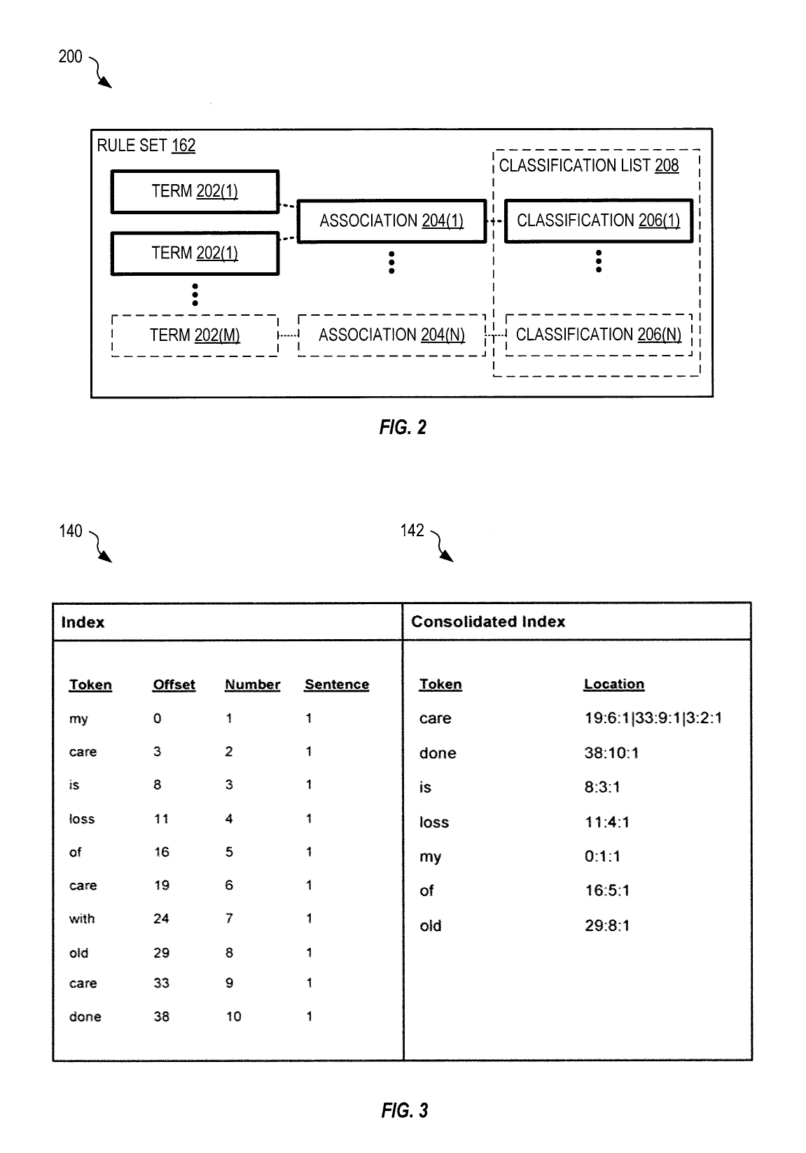

FIG. 2 shows rule set 162 in further exemplary detail. Rule set 162 defines one or more associations 204 between terms 202 and classifications 206. These classifications 206 are ordered, from most important to least important, within a classification list 208 for example, such that analyzer 160, when using rule set 162 to process text 110, may identify the most serious/sever classification for the text. In one embodiment, analyzer 160 processes association 204 within rule set 162 based upon a highest to lowest priority ordering of classification 206, such that once terms 202 of association 204 are matched, classification 206 defines the highest classification of text 110 and no further analysis using rule set 162 is required. However, other rule sets, if included, may be processed in turn to identify other classifications of text 110.

In one example of operation, rule set 162 include three levels of classification 206, “Top Secret”, “Secret”, and “Confidential” where “Top Secret” is more important (i.e., a higher priority classification) than “Secret,” and “Secret” is more important than “Confidential.” Thus, where text 110 includes tokens that match all terms within each of two associations 204 with classifications 206 of “Top Secret” and “Secret,” text 110 would be classified as “Top Secret.”

### Terms

Each term 202 includes one or more definitions for identifying certain tokens within consolidated index 142. Token 122 is determined as matching term 202 when any one or more definitions of term 202 match the token. Term 202 may currently have four types of term definitions:
1) Simple string match: Terms that are defined as a simple string are matched as a literal string comparison. The current implementation uses the SQL equality comparison operator to identify matching tokens.
2) Regular expression match: Terms that are defined with an enclosing m/ . . . /string will match tokens using the SQL implementation of regular expressions, which is designed to conform to POSIX 1003.2. This allows for a term to match content that isn't directly matched, such as a string containing an unknown number of random digits. The current implementation uses the SQL REGEXP operator to identify matching tokens. Future implementations may be adapted for other, more flexible, regular expression engines such as Perl compatible regular expressions.
3) Phrase match: definitions that are made up of multiple terms separated by spaces (component terms) are split and individually identified within the index. Whitespace and punctuation are not considered for analysis, so the term “my dog has fleas” will match a section that reads “I like the pest collar that my dog has. Fleas are never an issue.” Phrase matches build a temporary structure to represent the locations of unique components as single byte placeholders within a string. After all of the component tokens in the search are identified, the temporary structure is searched for the desired sequence of terms. The reported location of a matching phrase is the location of the first token in that phrase.
4) Included definitions: terms may “include” the contents of other terms by defining a term with an ‘@’ prefix. This is useful to clearly define collections when a classification guide defines associations such as “terms in column A and terms in column B.” When deployed, these definitions are recursively resolved into their collection matches, the equivalent of entering each term directly.

When terms 202 are being evaluated, a term definition is used to instantiate a code object that executes the logical test. The methods for matching terms may easily be extended with additional term definitions and methods.

### Associations

Each association 204 may include a plain language (usually quoted from the classification guide) text description of the association, an associated classification 206, and a list of one or more associated terms 202.

The list of associated terms is usually two terms, but in some specific cases having other numbers of terms may be useful, such as classification markings that are of individual interest may be represented in as association with a single term. Using more than two terms may be helpful to refine a match that is ambiguous. For example, “stuffed animal” could refer to a child's toy or a taxidermy mounting; additional terms within an association such as “teddy” could clarify the definition and reduce the number of false positive items within a report.

When all of the terms 202 listed in the association are matched to tokens in the text, the association is determined as appearing within the text. See Analysis below.

### Exporting and Importing Rule Sets

It is not sufficient to simply dump the underlying database tables of rule set 162 when exporting rule set 162 for use on another computer system, particularly where the underlying data store of one of these systems (source or destination) has been customized to use a different back end. Therefore, system 100 includes an export/import tool 170 that writes and reads rule set 162 to and from an export data file 172 that represents rule set 162 in a structured plaintext format.

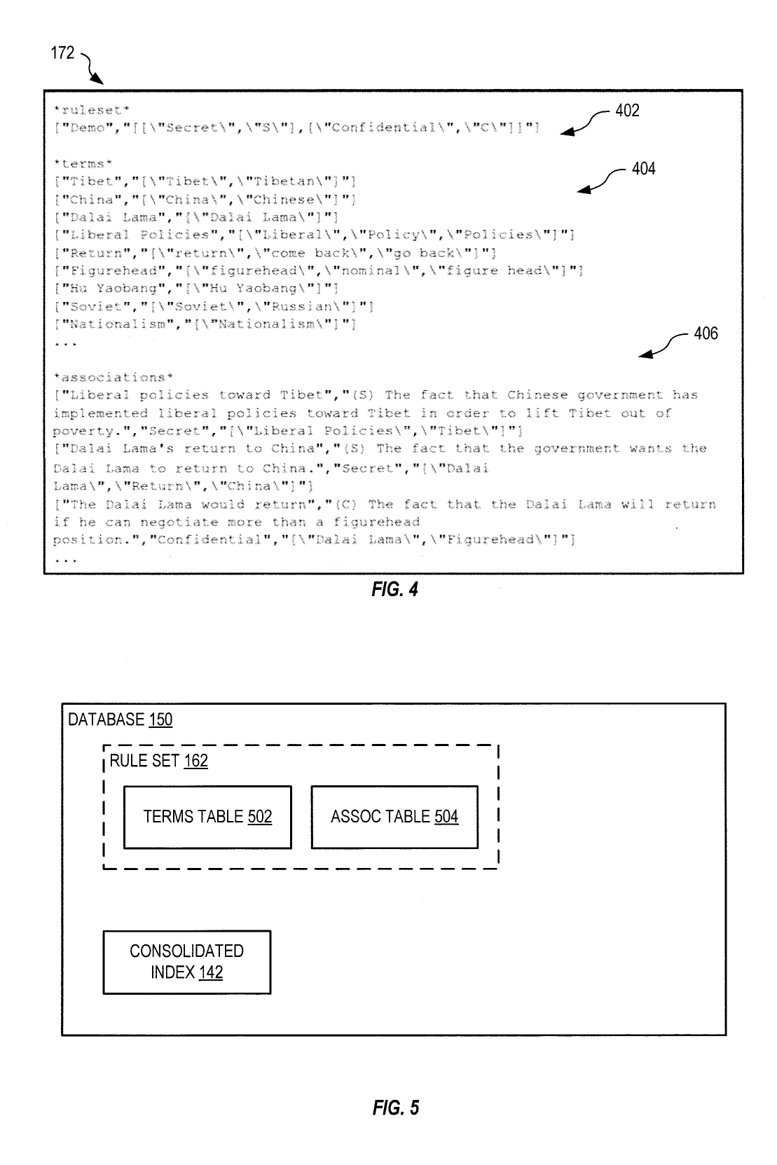

FIG. 4 shows export data file 172 with three exemplary sections: a rule set section 402, a terms section 404, and an associations section 406. The example of FIG. 4 is taken from a larger rule set and reformatted for clarity of illustration. Each section is identified by a header consisting of the section name surrounded by asterisks. After the header, JSON encoded data rows (separated by newlines) define each record within that section. Other methods for exporting and importing rule set 162 and generating export data file 172 may be used without departing from the scope hereof. Export data file 172 may also be created by a third party program.

Rule set section 402 includes a rule set name, a JSON encoded string containing classification terms and abbreviations. Rule set section 402 precedes all term and association definitions, since all following terms and associations are stored in association with the rule set name defined within rule set section 402.

Terms section 404 includes one or more arrays, each representing a separate rule. The first element in each array is a term name, and the second element in each array is a JSON encoded string defining a list of matching terms for that rule.

Associations section 406 includes one or more arrays, where each array represents a separate association. The first element of each array is an association name or summary, the second element in each array is a description of that association, the third element in each array defines the classification of that association, and the fourth element in each array is a JSON encoded string representing the terms related to this association.

Export/import tool 170 may also be operated to create rule set 162 from export data file 172, but does not necessarily deploy rule set 162.

### Deploying Rule Sets

FIG. 5 shows database 150 of FIG. 1 in further exemplary detail. Terms and associations of rule set 162 of FIG. 1 are made ready for use in analysis by deployment. Deploying rule set 162 creates, within database 150, a terms table 502 and an associations table 504. Tables 502 and 504 are named with the rule set name from rule set 162, followed by a “_assoc” and “_terms”suffix, respectively. Thus database 150 may store multiple rule sets.

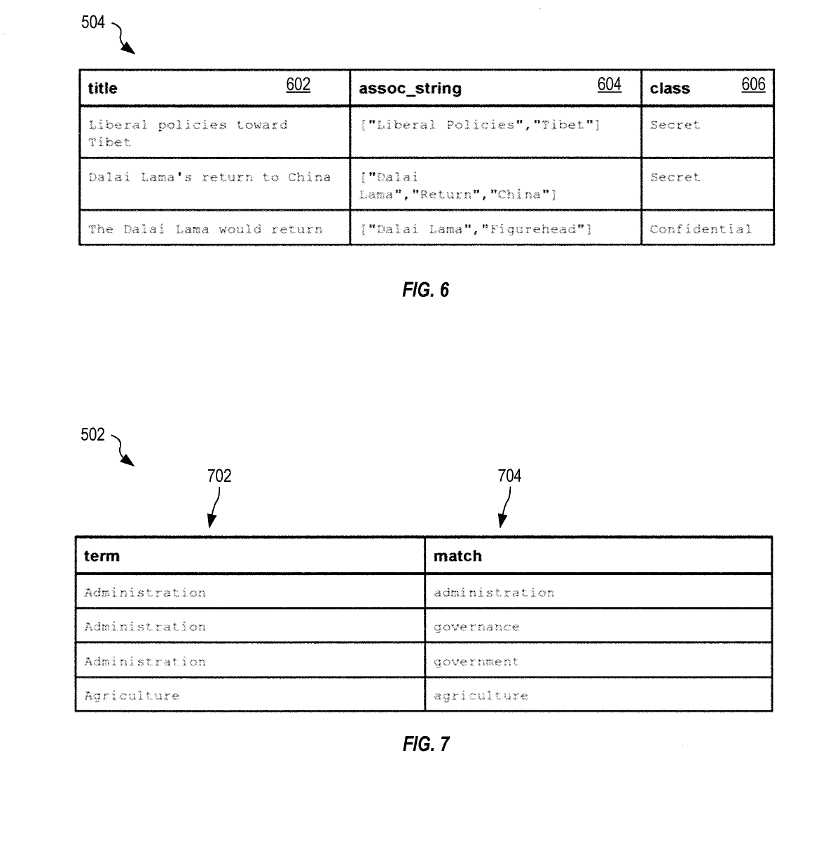

FIG. 6 shows associations table 504 of FIG. 5 with exemplary information. Table 504 includes a title field 602 for storing the title of the association, an association string 604 for storing a JSON encoded representation of the terms that make up that association, and a classification string that stores the classification of that association.

FIG. 7 shows terms table 502 of FIG. 5 with exemplary information. Table 502 includes a term field 702 that stores the term name, and a match field 704 that stores the match definition for each name/definition combination.

As noted above, “Include” rules are prefixed with an “at-sign” (‘@’) and are recursively resolved to define matches for the term. For example, within table 502, the expansion of each include rule generates matches wherein a single token may match multiple terms (e.g., the original term, and the including term), and multiple associations may result. For example, given term definitions A and B, which match the tokens “1” and “2”, respectively, term C may be defined to match the same tokens as terms A and B by referencing terms A and B using “@A” and “@B”, respectively, within the matching definition of term C. The implementation of this technique will generates term C to match tokens ‘1’ and ‘2’. Because this expansion of include rules occurs during deployment, changes to match definitions of terms A and B are automatically reflected in term C without the need to update match definitions of term C explicitly. That is, if term A is modified to also match a string “3”, C will then match strings “1”, “2”, and “3”.

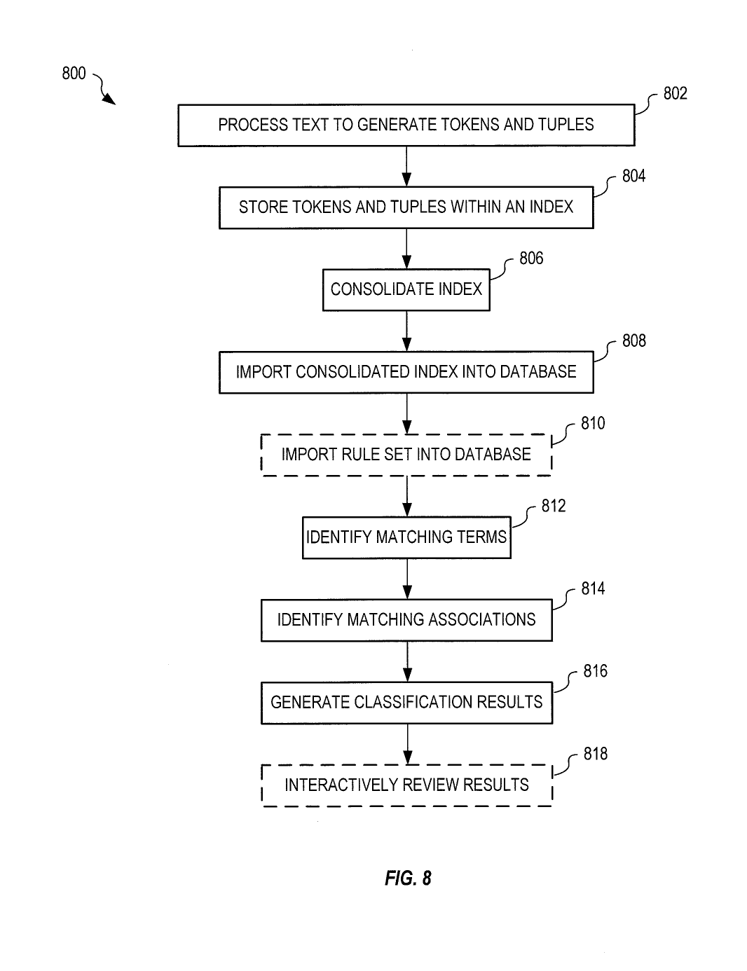

FIG. 8 is a flowchart illustrating one exemplary method 800 for automatically classifying text 110. Method 800 is for example implemented using system 100, of FIG. 1. Accordingly, step 802 of method 800 may be implemented within tokenizer 120 of system 100, FIG. 1. Steps 804 through 808 of method 800 are for example implemented within indexer 130. Steps 810 through 816 are implemented within analyzer 160 of system 100. Step 818 is implemented within user interface 166 of system 100.

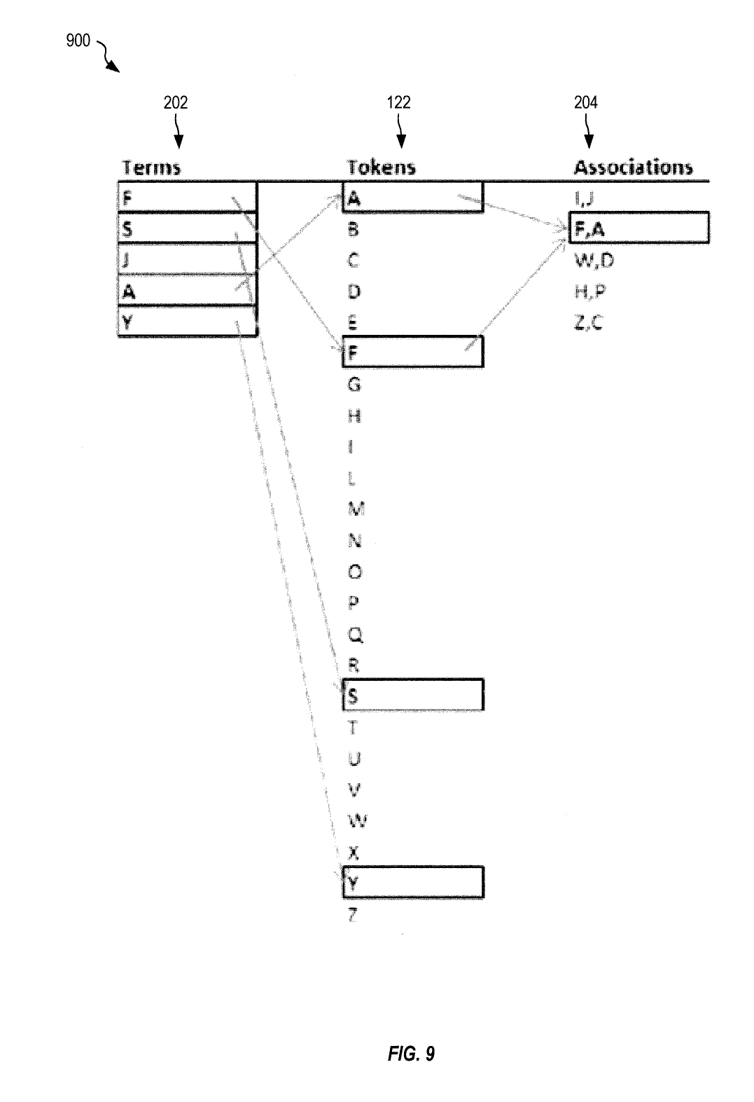

FIG. 9 is a schematic 900 illustrating exemplary matching between tokens 122 of text 110 and terms 202 and associations 204 of rule set 162. FIGS. 8 and 9 are best viewed together with the following description.

In step 802, method 800 processes text to generate tokens and tuples. In one example of step 802, tokenizer 120 processes text 110 to generate tokens 122 and tuples 124. In step 804, method 800 stores the tokens and tuples within an index. In one example of step 804, indexer 130 stores tokens 122 and tuples 124 within an index 140. In step 806, method 800 consolidates the index generated in step 804. In one example of step 806, indexer 130 consolidates index 140. In step 808, method 800 imports the consolidated index into a database. In one example of step 808, after consolidating index 140, indexer 130 sends index 140, consolidated in step 806, to database 150 for import as consolidated index 142.

Step 810 is optional, since rule set 162 may have been previously imported into database 150. If included, in step 810, method 800 imports a rule set into the database. In one example of step 810, export/import tool 170 imports rule set 162 into database 150 as terms table 502 and associations table 504.

In step 812, method 800 identifies matching terms. In one example of step 812, using the example of FIG. 9, analyzer 160 matches F, S, A, and Y terms 202, stored within terms table 502, with F, S, A, and Y tokens 122, respectively, of consolidated index 142. For example, all deployed terms 202 for each association 204 within the selected rule set 162 are matched against (iterated) tokens 122 within consolidated index 142 to identify matches. Matching terms are collected with their term name, location, and the matching token within memory 104 for example.

In step 814, method 800 identifies matching associations. In one example of step 814, using the example of FIG. 9, analyzer 160 matches F,A association 204 within associations table 504 with matched terms F and A of step 812. In step 816, method 800 generates results. In one example of step 816, analyzer 160 generates one or more classifications 206 based upon matched associations 204 and generates results 164. That is, the collection of matching terms is checked to see if it satisfies the terms configured as part of one or more associations. If all of the terms related to an association are identified as matching, the conditions of the association are fulfilled and the classification indicated by the association is reported. Association 204 is fulfilled when all terms 202 are matched to at least one token 122 within consolidated index 142. Associations that are not completely fulfilled are not reported.

Results 164 include, for each fulfilled association 204, a JSON string that defines matched tokens 122, their associated tuples 124, and information of the fulfilled association 204. In one example, where rule set 162 defines an association 204 with a first term that matches any series of digits and a second term that matches the word “security.” Where text 110 contains a number and the word “secret”, analyzer 160 generates results 164 to include the following (formatted for readability):

{

″associations″:[

{″terms″:[″Numbers″,”Security”],″class″:″Secret″,″title″:″Numbers″
}

```
  ],
  ″terms″:{
```

″Numbers″:[

{″loc″:″678:105:13″,″token″:″1128″},
{″loc″:″1791:269:28″,″token″:″7166″}

],
“Security”:[

{“loc”:”435:66:8”,”token”:”security”}

}

}

Results 164, in this example, indicates that analyzer 160 matched two numbers, “1128” and “7166,” and the word “security” within the same text, and that these terms were within an association called “Numbers” with a “Secret” classification.

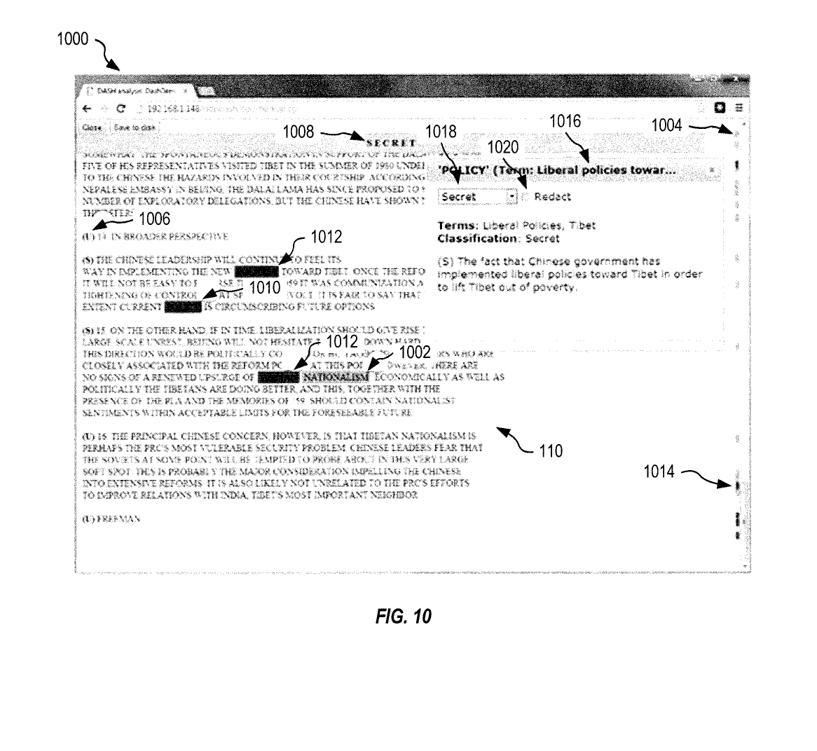

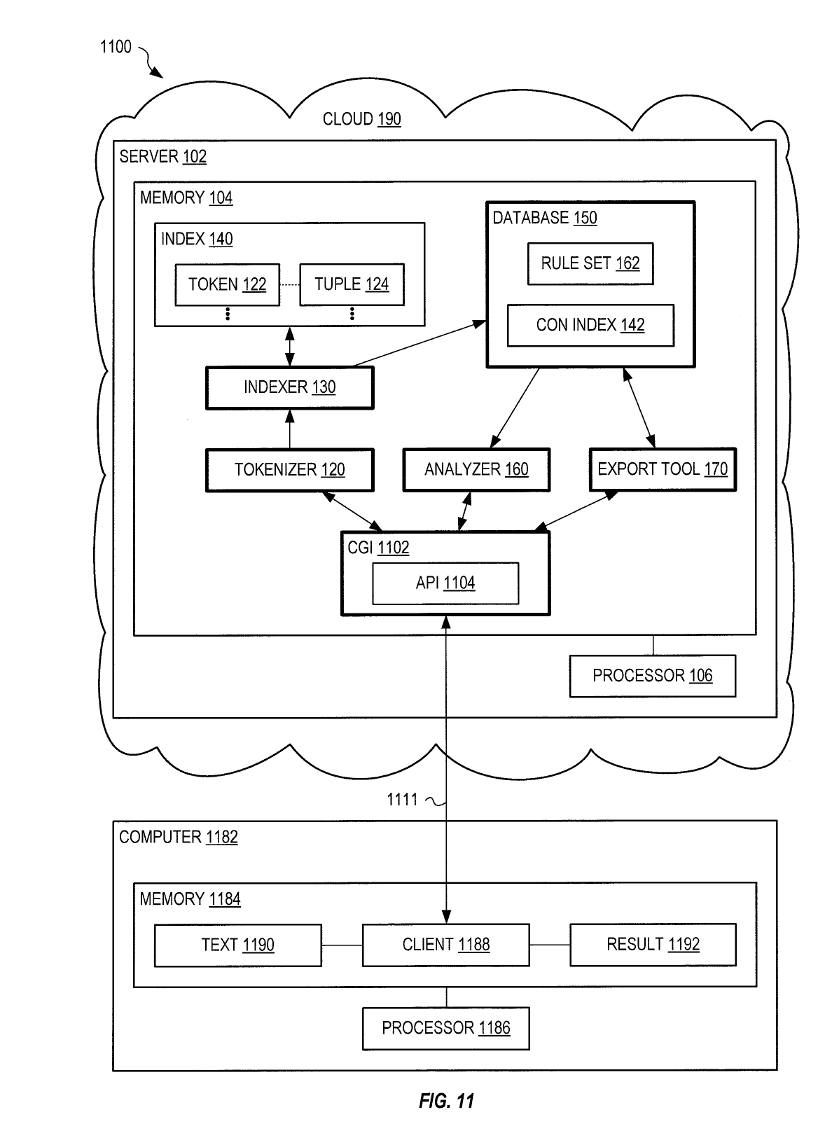

In the above example, the JSON string within results 164 is for human readability. However, analysis system 100 may provide one or more tools that automatically read results 164 and present the information contained therein to the user. Thus, results 164 need not be formatted for ease of human readability. For example, system 100 may allow the user to interactively review results 164 in combination with text 110. See FIG. 10 and the associated description for example. Step 818 is optional. If included, in step 818, method 800 interactively reviews the results. In one example of step 818, user interface 166 interacts with browser 198 of computer 192 to allow a user of computer 192 to interactively review results 164. Where text 110 represents a real-time data stream (e.g., a communication channel for email), browser 198 interacts with interface 166 to view results 164 in real-time (i.e., as they are generated by analyzer 160). Thereby, system 100 analyzes text 110 as it is created and informs the user (e.g., a security administrator) of computer 192 when the automatic classification of text 110 indicates that dissemination of text 110 should be prevented.

In one embodiment, once text 110 is analyzed by system 100, text 110 is marked according to results 164. FIG. 10 shows one exemplary interactive display screen 1000 showing text 110 with a highlighted term 1002, and location markers 1004 placed along the right hand margin of the view port. Paragraphs are analyzed, and each paragraph is given a classification mark 1006 to indicate the maximum classification of associations that relate to terms occurring within that paragraph. The text is given an overall classification mark 1008 according to the maximum classification of any paragraph.

Hovering over location marker 1004 displays a popup window containing a list of the terms being highlighted at that location. Clicking on one of the displayed terms scrolls the viewport such that the text containing the highlighted term is displayed within the viewport.

Clicking a highlighted term alters the highlight of that term 1010 and similarly highlights related terms 1012 throughout the text. Location markers 1004 also change their appearance to reflect the new highlighting as shown at 1014. This is done so that terms that are related by association may be easily identified throughout the text.

Clicking a term also displays a window 1016 that describes the associations that the term contributes to, the maximum classification marking of those associations, and a control 1018 to change the associated classification marking and a control 1020 that allows the reviewer to redact the term entirely, which also sets the classification marking of the term to “Unclassified.” Manual changes to the classification marking of a term also dynamically change the paragraph and text classification markings as appropriate.

After an interactive review is completed, an annotated version of the text may be downloaded, printed, etc. with the capabilities of the web browser and operating system. For example, system 100 may generate a report that includes the annotated version of the text, thereby facilitating use of system 100 to “batch process” two or more texts (i.e., documents) automatically.

### Example of Use

A classified government program may implement its rules for information classification within a classification guide, assigning a “Secret” classification to certain associations of terms such as those that identify the program itself and where the program operates. Terms 202 are created to include words, phrases, numbers, and other characteristics of the government program's identity. Also, characteristics of the program's operational locations may be included within terms 202. Rule set 162 is generated to associate classification 206 of “Secret” with these terms 202 within an association 204. Upon matching terms 202 with tokens 122 of text 110 to fulfill association 204, analyzer 160 classifies text 110 as “secret.”

System 100 supports due diligence when reviewing text for reclassification or release. In one embodiment, system 100 is implemented as a centrally administered web service that performs text analysis, and includes, and/or provides, tools that present results from analysis of the text to the user and allows interactive review of the results by the user.

System 100 may be considered a specialized search engine application that automatically analyzes text within a single document with a number of configured rules to identify terms that, when combined, may form an association that requires further analysis. System 100 does not require natural language comprehension; it is deliberately deterministic in its techniques.

### The Web Service

FIG. 11 shows one exemplary system 1100 that includes a common gateway interface (CGI) 1102 and operates to automatically determine a classification of text 1190. System 1100 is similar to system 100 but includes CGI 1102 for interfacing with a computer 1182 via a communication path 1111 to allow a client 1188, operating on computer 1182 to read, index, and analyze text 1190 and receive a result 1192 (e.g., as a JSON string described above) that classifies text 1190. CGI 1102 may implement an application programming interface (API) 1104 that allows client 1188 to send text 1190 via communication path 1111 to system 1100 and receive in return result 1192 that classifies text 1190 based upon rule set 162. API 1104 may also allow client 1188 to create, modify, and export rule set 162.

FIG. 1 shows system 100 cooperating with browser 198 operating within computer 192. However, system 100 may utilize other types of interface without departing from the scope hereof. For example, interface 166 may communicate with a word processor and/or email program running on computer 192, wherein system 100 tokenizes text as it is typed within these programs, and then created consolidated index 142 as these tokens are determined. Integration with the word processor and/or email program may thereby provide real-time classification of text as it is typed, automatically displaying determines classifications within the text as the user types.

In another embodiment, system 100 operates as a communication proxy (e.g., an instant-messaging proxy) that automatically analyzes and classifies texts within typed messages, alerting the user when the typed message contains classified terms, and optionally blocking messages from being transmitted when classified at or above a particular classification severity. Thus, system 100 may operate on a per-conversation basis.

In another embodiment, system 100 cooperates with, or is integrated within, a “continuous integration” system, such as Jenkins, to automatically scan and report classification of stored and managed documents. For example, each document stored within the continuous integration system may be automatically classified and allow a user to interactively view and modify the document as described above.

System 1100 operates similar to system 100, described above, to tokenize, index, consolidate, and analyze text 1190 based upon rule set 162 and to return results 1192 to indicate classification of text 1190.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A method for determining classification of text displayed within a browser on a computer, comprising:
generating, using a processor within a server, a consolidated index of tokens contained within the text;
identifying a first classification of the text by matching, using the processor, each of one or more first terms of a first association defined within a rule set with the tokens of the consolidated index, the first association associating the one or more first terms with the first classification; and
interacting with the browser to indicate the first classification with the text.

2. The method of claim 1, further comprising:
identifying a second classification of the text by matching, using the processor, each of one or more second terms of a second association defined within the rule set with the tokens of the consolidated index, the second association associating the one or more terms with the second classification;
interacting with the browser to indicate the second classification with the text; and
interacting with the browser to indicate an overall classification of the text based upon a most important of the first classification and the second classification.

3. The method of claim 1, the step of interacting comprising displaying a classification mark based upon the first classification proximate the text, wherein the text includes a paragraph of a document displayed within the browser.

4. The method of claim 3, further comprising displaying a location marker along the right hand margin of the browser to indicate a location within the text of each token that matches with at least one of the first terms of the first association.

5. The method of claim 4, further comprising highlighting the matched token in an alternative color when selected by the user within the browser.

6. The method of claim 4, further comprising redacting the matched token from the text in response to receiving a redact command from the user.

7. The method of claim 1, further comprising displaying the first association when the matched token is selected by the user within the browser.

8. A method for communication stream text classification, comprising:
continually receiving, within a server, characters from the communication stream;
tokenizing, using a processor of the server, the characters to generate a consolidated index of tokens contained within the text;
identifying a classification of the communication stream text by matching, using the processor, each of one or more terms of an association defined within a rule set with the tokens of the consolidated index, the association associating the one or more first terms with the classification; and
reporting the classification to a user of the communication stream.

9. The method of claim 8, the step of tokenizing further comprising time-stamping the tokens, wherein the step of identifying comprises matching each of the one or more terms to tokens of the consolidated index within a sliding time-window.

10. The method of claim 9, wherein the classification is the most important classification defined within a plurality of associations for which all terms are matched to tokens within the sliding time-window.

11. A software product comprising instructions, stored on non-transitory computer-readable media, wherein the instructions, when executed by a processor, perform steps for determining text classification, comprising:
instructions for interacting with a browser operating on a user's computer to display the text;
instructions for generating a consolidated index of tokens contained within the text;
instructions for identifying a first classification of the text by matching each of one or more first terms of a first association defined within a rule set with the tokens of the consolidated index, the first association associating the one or more first terms with the first classification; and
instructions for interacting with the browser to indicate the first classification with the text.

12. The software product of claim 11, further comprising:
instructions for identifying a second classification of the text by matching each of one or more second terms of a second association defined within the rule set with the tokens of the consolidated index, the second association associating the one or more second terms with the second classification;
instructions for interacting with the browser to indicate the second classification with the text; and
instructions for interacting with the browser to indicate an overall classification of the text based upon a most important of the first classification and the second classification.

13. The software product of claim 11, further comprising instructions for displaying a classification mark based upon the first classification proximate the text, wherein the text includes a paragraph of a document displayed within the browser.

14. The software product of claim 11, further comprising instructions for displaying a location marker along the right hand margin of the browser to indicate a location within the text of each token that matches with at least one of the first terms of the first association.

15. The software product of claim 14, further comprising instructions for redacting the matched token from the text in response to receiving a redact command from the user.

16. The software product of claim 11, further comprising instructions for highlighting the at least one token in a first color within the browser.

17. The software product of claim 16, further comprising instructions for highlighting the at least one token in a second color when the at least one token is selected by the user within the browser.

18. The software product of claim 16, further comprising instructions for displaying the first association when the matched token is selected by the user within the browser.
